(19) United States
(12) Patent Application Publication
(10) Pub. No.: US 2026/0161665 A1
(43) Pub. Date: Jun. 11, 2026

(54) FEDERATED HIERARCHICAL DATA MANAGEMENT USING UNIFORM OBJECT LOCATOR RANGES

(71) Applicant: Jon Lee Boynton, North Fort Myers, FL (US)

(72) Inventor: Jon Lee Boynton, North Fort Myers, FL (US)

(21) Appl. No.: 19/411,266

(22) Filed: Dec. 7, 2025

Related U.S. Application Data
(60) Provisional application No. 63/728,739, filed on Dec. 6, 2024.

(51) Int. Cl. G06F 16/28; G06F 16/215; G06F 21/64

(52) U.S. Cl. CPC G06F 16/282; G06F 16/215; G06F 21/64

(57) ABSTRACT

A system and method for managing distributed hierarchical data using Uniform Object Locator (UOL) ranges in a federated network. A master node maintains a centralized registry of non-overlapping UOL range entries to filter and route create, read, update, delete (CRUD) operations and search queries exclusively to the affiliate node(s) responsible for each UOL key. Range entries are of consecutive or collated type and employ specialized comparison logic that respects both lexicographic and hierarchical relationships. The architecture eliminates data replication, prevents key collisions, and supports efficient streaming of deduplicated UOL paths, enabling scalable management of extremely deep or variable-depth hierarchies.

### CROSS-REFERENCE TO RELATED APPLICATIONS

This application claims priority under 35 U.S. C § 119(e) to U.S. Provisional Patent Application Ser. No. 63/728,739, filed Dec. 6, 2024.

### FIELD OF THE INVENTION

The present invention relates generally to distributed database systems and, more particularly, to systems and methods for collision-free routing of hierarchical data using specialized ranges.

### BACKGROUND OF THE INVENTION

Traditional distributed databases achieve availability and scalability through data replication or complex consistency protocols, resulting in increased storage requirements and network overhead. Hierarchical data structures exacerbate these problems because conventional sharding and partitioning schemes fail to express or enforce boundaries that simultaneously respect lexical ordering and parent-child relationships. There remains an unmet need for a replication-free federated architecture capable of routing queries directly to the single node responsible for a given hierarchical key without cross-node coordination, while supporting efficient range queries and streaming results across hierarchies of arbitrary depth.

### SUMMARY OF THE INVENTION

The present invention provides a distributed hierarchical data management system and associated methods in which a master node maintains a registry of non-overlapping UOL range entries, each entry defining immutable start and end boundaries of either consecutive or collated type and each associated with one or more affiliate nodes. Range-specific comparison methods enable precise determination of whether a candidate UOL key falls within a given range. Upon receiving a query containing one or more UOL keys, the master node routes each key exclusively to the affiliate node(s) whose registered range contains that key, thereby eliminating replication and preventing key collisions. The system further leverages deduplication techniques for context and name components to minimize bandwidth during query and result transmission.

### BRIEF DESCRIPTION OF THE DRAWINGS

For a more complete understanding of the subject matter and the advantages thereof, reference is now made to the following descriptions taken in conjunction with the accompanying drawings, in which:

FIG. 1 illustrates an example Uniform Object Locator (UOL).

FIG. 2 illustrates an example consecutive UOL range.

FIG. 3 illustrates an example collated UOL range covering an entire subtree.

FIG. 4 illustrates a subset collated UOL range using name qualified boundaries.

FIG. 5 illustrates a consecutive UOL range with an undefined end boundary.

FIG. 6 depicts an example range registry table maintained by a master node.

FIG. 7 is a block diagram of an exemplary master node according to one embodiment.

FIG. 8 is a block diagram of an exemplary affiliate node according to one embodiment.

FIG. 9 is a flowchart depicting the process by which membership of a candidate UOL key in a collated range is determined

### DETAILED DESCRIPTION OF SOME EXAMPLE EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code.

### A. Uniform Object Locator (UOL) Syntax

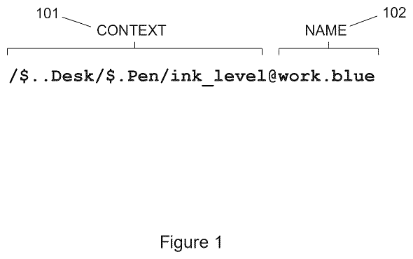

A Uniform Object Locator (UOL) is defined herein as a subset of Uniform Resource Identifiers (URIs) that conforms to the generic syntax of RFC 3986. FIG. 1 Illustrates an example UOL. For clarity as to the benefits offered by UOL keys in distributed hierarchical data systems, the example UOL will now be described in detail.

The UOL consists of a string of characters having, at most, one commercial ‘@’ delimiter. The substring of characters preceding the ‘@’ is herein referred to as the context component or context (101). The substring of characters following the ‘@’ is herein referred to as the name component or name (102). Together, the context, ‘@’, and name comprise a complete UOL path component. The separation of context and name components facilitates efficient deduplication of UOLs in data streams.

Hierarchical segments of a context component (delimited by “/” characters) may contain one or more ordinal name anchors denoted by the “$” character. Each “$” (or sequence of “$” characters) is positionally bound from left to right to corresponding hierarchical levels in the name component (delimited by “.” characters), thereby preserving hierarchical relationships during comparison and transformation; facilitating efficient range-based operations.

While described with respect to UOLs, it will be apparent to one skilled in the art, the invention supports other URI variations with similar context and name components using anchors to positionally bind hierarchical context and name segments, all referred to herein as UOL or UOLs.

### B. Incorporation of Deduplication Techniques

The master and affiliate nodes perform deduplication of context and name component according to the methods described in co-pending U.S. patent application Ser. No. 19/292,862, filed on Aug. 6, 2025. These techniques are used bidirectionally during query and result streaming to minimize bandwidth when transmitting large UOL-based datasets.

For clarity as to use in embodiments, an incorporated deduplication method is described by the following:

A process receives a data stream with UOLs, each having a context component and a name component. UOLs are split into context and name components. A unique token for each component is obtained from a dictionary; wherein, new components are assigned new tokens and duplicate components reuse existing tokens. The deduplicated components and tokens are written to a data stream along with unique component-token pairs representing UOLs. A reverse process is used to reconstruct UOLs from unique component-token pairs using a dictionary of deduplicated components and tokens.

### C. Consecutive and Collated Ordering

UOL keys are primarily compared lexicographically; with context and name components evaluated separately. Comparison proceeds character-by-character from left to right via subtraction of Unicode code values, commencing with the context component. The first differing character pair dictates the order: a negative difference places the first UOL before the second, a positive difference after. If context components match, evaluation extends to the name component. Identical paths across both components yield equality of the two UOLs. In an optional numeric-aware comparison mode, segments within the name component separated by ‘.’ characters are interpreted as numeric values when possible, such that ‘A.10’ is ordered after ‘A.2’.

Sorting an index of UOL keys with the preceding algorithm would yield a consecutive ordering with vertical alignment of context components. This ordering optimizes for queries that iterate over columns of data within the same table or object.

While consecutive ordering follows standard lexicographic comparison, as seen in prior art, the invention centers on a specialized collated ordering, where hierarchy has precedence over consecutive order. In some embodiments, a specialized collated ordering is defined for range boundary evaluation; wherein a range has start and end UOL boundaries.

For collated ordering, when a UOL key shares a common ancestor with a boundary, comparison begins at the relative child UOLs below the deepest common ancestor. Thus, ensuring that both paths are within the same hierarchy. Comparison continues up to the end of the boundary path. If comparison yields equality, and the key is a descendant of the boundary, it is treated as greater than the start boundary and less than an end boundary.

### D. UOL Ranges

In embodiments, A UOL range defines boundaries for grouping UOL keys into unique, addressable subsets within an index or collection. The range specifies immutable “start” and “end” UOL boundaries upon creation, enforcing membership rules to accept only qualifying UOL keys. At least two range types exist: consecutive and collated.

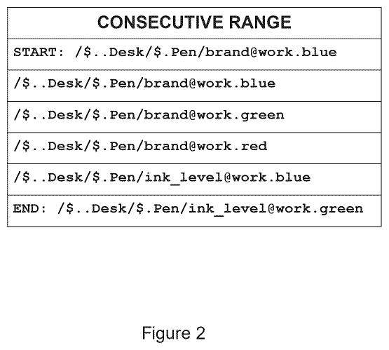

Consecutive ranges accept keys that must be greater than or equal to a start boundary, and explicitly less than an end boundary (FIG. 2); herein referred to as consecutive ordering. Suitable when exact minimum and maximum keys are known.

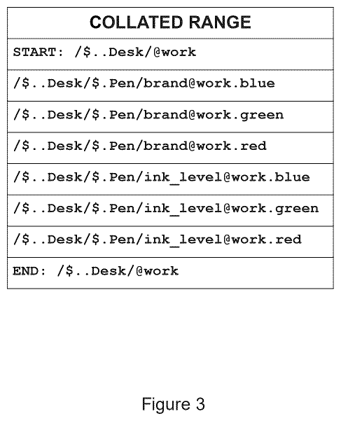

Collated ranges accept keys that must be greater than or equal to, or descendant from, a start boundary, and less than, or descendant from, an end boundary (FIG. 3); herein referred to as collated ordering. When the start boundary and end boundaries of a collated range are identical, the range includes the boundary key itself and all descendants. This type accommodates hierarchical groupings with unknown bounds.

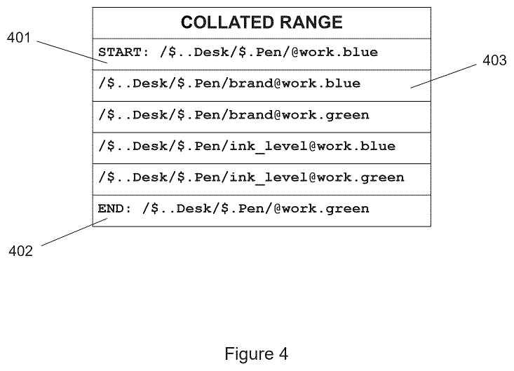

For clarity as to the distinction between range types, FIG. 2 illustrate an exemplary consecutive range, while FIG. 3 illustrates a collated range covering an entire subtree rooted at ‘/$..Desk/@work’. FIG. 4 illustrates a subset of the collated range specified in FIG. 3 using the start boundary ‘/$..Desk/$.Pen/@work. blue’ (401) and the end boundary ‘/$..Desk/$.Pen/@work.green’ (402). The first UOL key in the listed set (403) is ‘/$..Desk/$.Pen/brand@work.blue’. When compared with collated ordering, the key and the end boundary have the same ancestor ‘/$..Desk/@work’. Thus, comparison is made by relative UOLs ‘./$.Pen/@blue’ and ‘./$.Pen/@green’, derived from the deepest common ancestor; wherein, “blue” is less than “green.”

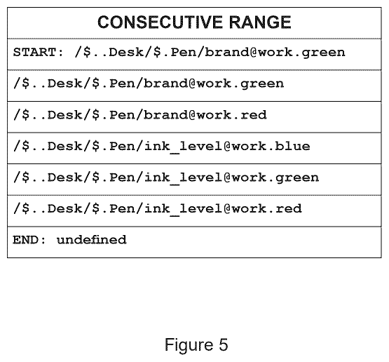

For both range types, unspecified start boundaries omit start rules, unspecified end boundaries omit end rules, and unspecified for both yield unbound ranges ignoring all rules. FIG. 5 illustrates a consecutive range where the end boundary is undefined, allowing inclusion up to infinity.

In some embodiments, keys accepted within a collated range are stored and indexed using consecutive ordering. This method provides for efficient data iteration while preserving hierarchical relationships.

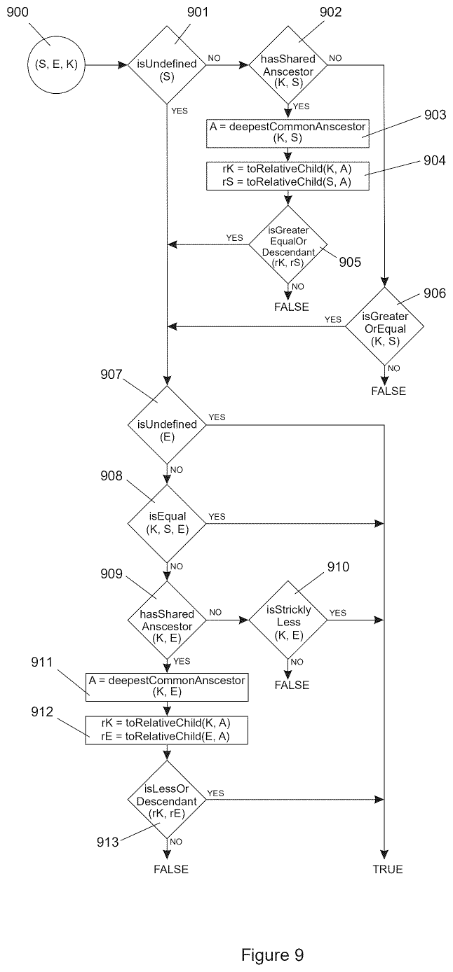

To fully understand the relationship between UOL keys and collated ranges, FIG. 9 presents a flowchart depicting the process by which a master node (and, where applicable, affiliate nodes) determines whether a candidate UOL key falls within the boundaries of a collated range. Beginning at start block 900, the process receives a candidate UOL key K, a start boundary S, and an end boundary E (either or both of which may be undefined).

At the first decision block (901), the process determines whether S is undefined. If YES, the range has no start boundary; processing skips to the end boundary test (907). If defined, flow proceeds to the next decision block (902) to determine if K shares a common ancestor UOL with S.

If K and S do not share an ancestor, the process decides if K is greater than or equal to S (906) using consecutive ordering. If YES, processing continues to end-boundary testing (907). If NO, the process returns FALSE.

If K and S share a common ancestor, the process determines the deepest common ancestor UOL “A” (903), then determines the relative child UOLs that descend from A (904). These are indicated using rK and rS for relatives of K and S respectively. Proceeding to the next decision block (905), if rK is greater than or equal to, or a descendant of, rS (collated ordering), the membership check continues to end-boundary testing (907). Otherwise, the process returns FALSE.

If the end boundary test block (907) determines E is undefined, the range has no end boundary; flow proceeds to terminal and returns TRUE. If defined, the next decision block (908) determines if K, S, and E equal each other. If YES, flow proceeds to terminal and returns TRUE. If NO, flow proceeds to the next decision block (909) to determine if K shares a common ancestor UOL with E.

If K and E do not share an ancestor, the process decides if K is strictly less than or equal to E (910) using consecutive ordering. If YES, flow proceeds to terminal and returns TRUE. If NO, the process returns FALSE.

If K and E share a common ancestor, the process determines the deepest common ancestor UOL “A” (911), then determines the relative child UOLs that descend from A (912). These are indicated using rK and rE for relatives of K and E respectively. Proceeding to the next decision block (913), if rK is less than, or a descendant of, rE (collated ordering), flow proceeds to terminal and returns TRUE. Otherwise, the process returns FALSE.

### E. Range Registry and Collision Avoidance

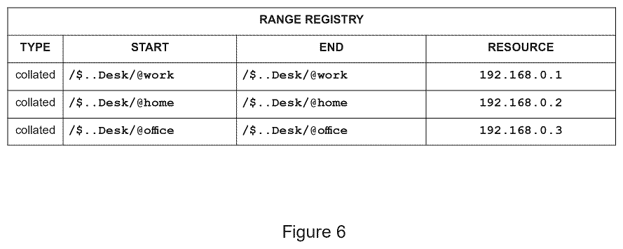

In embodiments of the present invention, a master node maintains a centralized registry of non-overlapping range entries, each comprising: range type, start UOL (possibly undefined), end UOL (possibly undefined), and network address or identifier of the responsible affiliate(s) (FIG. 6). Before registering a new range, the master node verifies non-overlap by checking that no existing range contains the new start boundary and that the new range does not contain any existing start boundary. Thus, efficiently determining that no UOL key can be addressed to more than one registered node.

Range splitting is supported when partial assignment is required. Any UOL key contained by the range can be a divider. Using the selected divider UOL, splitting produces two ranges: a first range with the start boundary of the original and the divider as an end boundary, and a second range with the divider as a start boundary and the end boundary equal to the original end boundary. The first and second range retain the type of the original.

### F. System Operation

In some embodiments, the invention may be implemented as a distributed hierarchical data management system comprising a master node maintaining a registry of unique, non-overlapping, UOL ranges, each associated with one or more affiliate nodes in a federated network. Each range defines immutable boundaries (start and end UOL keys) classified as consecutive or collated, as detailed herein, enabling precise grouping of data into addressable subsets without replication. Affiliate nodes store indexes of one or more such non-overlapping ranges, controlling access to data identifiable via UOL keys falling within those boundaries; a range registry may aggregate ranges from multiple affiliates for centralized routing.

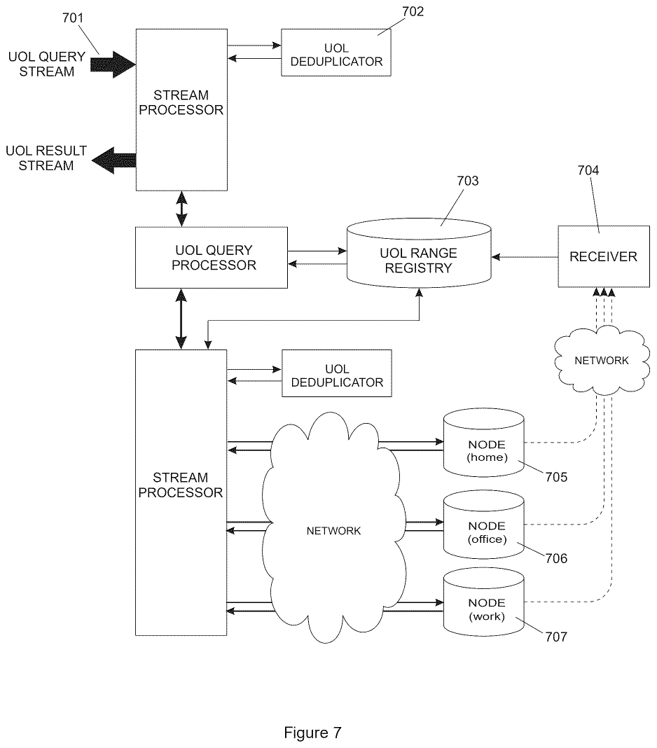

FIG. 7 illustrates an exemplary Master Node within the above system. A deduplicated UOL-based query stream (701) is received from a client application. The master node reconstructs full verified UOLs (702), decomposes the query into sub-queries via UOL comparison to registered ranges (703), routes each sub-query containing a UOL key exclusively to the affiliate(s) whose registered range contains that key (705,706,707).

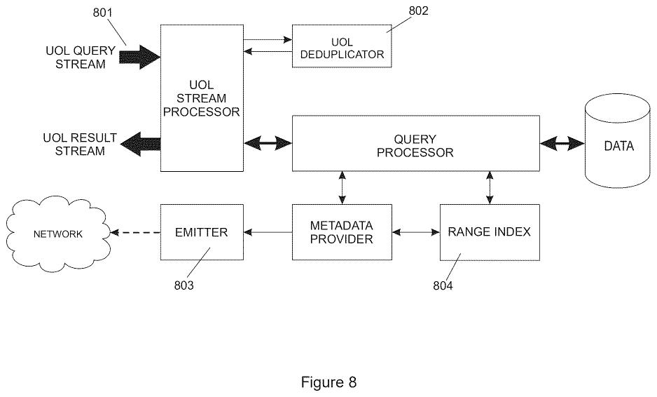

FIG. 8 illustrates an exemplary Affiliate Node within the above system. A deduplicated UOL-based query stream (801) is received from a master node. The affiliate node reconstructs full verified UOLs (802), decomposes the query into sub-queries via UOL comparison to locally indexed ranges (804), executes operations (e.g., search, CRUD) on the associated data, and returns deduplicated result streams to the master node.

The master node receives query results from affiliates, combines results via processing, and returns a deduplicated UOL data stream to the client. Both master and affiliate nodes incorporate UOL deduplication, for bidirectional request and response streaming over the network.

### G. Dynamic Registry Maintenance

Affiliate nodes periodically emit heartbeat messages at a configurable interval (803). The message contains a cryptographic hash of each affiliate's current set of ranges. The master node receives heartbeat messages (704) and detects changes. Upon detecting a hash mismatch, the master node requests new range metadata from the affiliate, compares new metadata against existing registered ranges, validates non-overlap, and updates the range registry (703); ensuring continuous collision-free operation despite node addition, removal, or range reassignment.

The foregoing embodiments are illustrative rather than limiting. Persons skilled in the art will recognize that numerous modifications and variations are possible without departing from the scope of the invention as set forth in the appended claims.

1. A distributed hierarchical data management system comprising:
a master node configured to maintain a registry of a plurality of non-overlapping Uniform Object Locator (UOL) range entries, each range entry defining a range type selected from consecutive and collated, an optional start UOL boundary, an optional end UOL boundary, and at least one affiliate node identifier;
and a plurality of affiliate nodes in network communication with the master node;
wherein the master node is configured to receive a query containing at least one UOL key, determine, for each said UOL key, exactly one affiliate node whose registered range entry contains said UOL key using range-type-specific membership rules, and route a corresponding sub-query exclusively to said determined affiliate node.

2. The system of claim 1, wherein the master node, before inserting a new range entry into the registry, performs a non-overlap validation comprising:
confirming that no registered range entry contains the start boundary of the new range entry, and confirming that the new range entry does not contain the start boundary of any registered range entry.

3. The system of claim 1, wherein membership of a candidate UOL key in a collated range is determined by executing the steps illustrated in figure 9.

4. The system of claim 1, wherein a consecutive range contains a candidate UOL key K when K is greater than or equal to the start boundary and strictly less than the end boundary under consecutive ordering.

5. The system of claim 1, wherein queries and result sets are transmitted between the master node and the affiliate nodes in a deduplicated format in which context components and name components of UOLs are separately tokenized and reused.

6. The system of claim 1, wherein the system supports splitting an existing range entry along any divider UOL contained within said existing range entry, thereby producing two new non-overlapping range entries that inherit the range type of the original range entry.

7. The system of claim 1, wherein each affiliate node is configured to periodically transmit to the master node a heartbeat message containing a cryptographic hash of the affiliate node's current local set of range entries, and the master node is configured, upon detecting a hash mismatch, to request and incorporate updated range metadata into the registry after successful non-overlap validation.

8. The system of claim 1, wherein ordinal anchor characters (‘$’) in a context component of a UOL bind corresponding context segments to name segments, thereby enabling hierarchical comparison during collated range evaluation.

9. The system of claim 1, wherein the registry supports numeric-aware comparison in which numeric segments within the name component are compared as integers rather than lexicographically (e.g., ‘2’ preceding ‘10’).

10. A computer-implemented method for collision-free routing of hierarchical data operations in a federated network, the method comprising:
receiving, at a master node, a client query containing one or more Uniform Object Locators (UOLs);
reconstructing full UOLs from a deduplicated query stream;
for each reconstructed UOL key K:
traversing a registry of non-overlapping range entries maintained by the master node, each entry having a consecutive or collated type;
identifying exactly one range entry that contains K using range-type-specific membership tests;
forwarding the portion of the query pertaining to K exclusively to the affiliate node(s) associated with the identified range entry; and aggregating deduplicated results received from the affiliate nodes and returning a deduplicated result stream to the client.

11. The method of claim 10, wherein the master node, before inserting a new range entry into the registry, performs a non-overlap validation comprising:
confirming that no registered range entry contains the start boundary of the new range entry, and confirming that the new range entry does not contain the start boundary of any registered range entry.

12. The method of claim 10, wherein each affiliate node periodically transmits to the master node a heartbeat message containing a cryptographic hash of the affiliate node's current local set of range entries, and the master node, upon detecting a hash mismatch, requests and incorporates updated range metadata into the registry after successful non-overlap validation.

13. The method of claim 10, wherein membership of a candidate UOL key in a collated range is determined using the hierarchical inclusion logic depicted in FIG. 9.

14. The method of claim 10, wherein a consecutive range contains a candidate UOL key K when K is greater than or equal to the start boundary and strictly less than the end boundary under consecutive ordering.

15. The method of claim 10, further comprising:
receiving a request to split an existing registered range entry along a divider UOL contained within said existing range entry;
creating two new range entries that inherit the range type of the original range entry, a first new range entry having the original start boundary and the divider UOL as its end boundary, and a second new range entry having the divider UOL as its start boundary and the original end boundary;
and replacing the original range entry with the two new range entries in the registry.

16. The method of claim 10, wherein ordinal anchor characters (‘$’) in a context component of a UOL bind corresponding context segments to name segments, thereby enabling hierarchical comparison during collated range evaluation.

17. The method of claim 10, wherein the registry supports numeric-aware comparison in which numeric segments within the name component are compared as integers rather than lexicographically (e.g., ‘2’ preceding ‘10’).

18. A non-transitory computer-readable medium storing instructions that, when executed by one or more processors, cause the one or more processors to perform the method of claim 10.

19. A method of determining whether a candidate Uniform Object Locator (UOL) key falls within a collated range having a start boundary S and an end boundary E, the method comprising the sequence of steps illustrated in FIG. 9 and described in paragraphs [0034]-[0040] of the specification.
